(19) United States
(12) Patent Application Publication
(10) Pub. No.: US 2016/0330954 A1
(43) Pub. Date: Nov. 17, 2016

(54) Coating Composition with Sustained Release

(71) Applicant: Valspar Sourcing, Inc., Minneapolis, MN (US)

(72) Inventors: Jianping Sun, Foshan City (CN); Tao Wang, Foshan City (CN); Gang Duan, Northbrook, IL (US); Xiaorui Chen, Foshan City (CN); Xi Zhao, Foshan City (CN); Rong Xiong, Foshan City (CN); Hui Kou, Foshan City (GD); Yingjie Fan, Foshan City (CN)

(73) Assignee: Valspar Sourcing, Inc., Minneapolis, MN (US)

(21) Appl. No.: 15/221,828

(22) Filed: Jul. 28, 2016

Related U.S. Application Data
(63) Continuation of application No. PCT/US2015/024524, filed on Apr. 6, 2015.

(30) Foreign Application Priority Data
Apr. 22, 2014 (CN) 201410164256.6

(51) Int. Cl. A01N 25/28; C09D 5/02; C09D 5/14; C09D 125/14; C09D 133/08

(52) U.S. Cl. CPC A01N 25/28; C09D 125/14; C09D 133/08; C09D 5/14; C09D 5/022; C08K 5/00

(57) ABSTRACT

The present disclosure relates to an aqueous dispersion for sustained release of a functional component useful for a coating composition, and a preparation process and use thereof. The aqueous dispersion comprises polymeric particles with a polymeric core-shell structure and the functional component contained in the polymeric core of the polymeric particles, wherein the polymeric shell has Tg of 20° C. or less, and wherein the functional component has a water solubility of 10 g/100 g water or less at room temperature.

### CROSS-REFERENCE TO RELATED APPLICATION(S)

This application is a continuation of International Application No. PCT/U.S.2015/024524, filed 6 Apr. 2015, which claims priority from Chinese Patent Application No. 201410164256.6, filed Apr. 22, 2014, and entitled “Aqueous Dispersion For Sustained Releasing Functional Component Useful For Coating Composition, and Preparation Process and Application Thereof,” each of which is incorporated herein by reference in its entirety.

### TECHNICAL FIELD

The present disclosure relates to an aqueous dispersion and a preparation process thereof. Specifically, the present disclosure relates to an aqueous dispersion for sustained release of a functional component useful for a coating composition, and a preparation process thereof. The present disclosure further relates to a coating composition comprising the aqueous dispersion.

### BACKGROUND

A coating composition can be applied to various products used in various applications, such as residential applications, commercial applications and industrial applications to form coatings. The products comprise wood products, metal materials, wall covering materials, textiles, and so on. As one of the most important components in the coating composition, a film-forming resin in the form of an aqueous dispersion would generally determine the basic performances of the coating composition, such as film-forming property, durability, weather resistance, and so on.

In order to endow the coating with the required additional functionalities, corresponding functional components, such as a phase transfer material, a repellent, an anti-bacterial agent, a fungicide, an essence oil, a perfume, a formaldehyde scavenging agent, an acid scavenging agent, and so on, are often added into the coating composition. It is known that these functional components can be embedded in polymeric materials and added into the coating composition in a microcapsule form for sustained release. Generally, in a process of preparing the coating composition, the various components need to be stirred vigorously for uniform mixing. With stirring, the rupture of capsule walls of the functional components added in the microcapsule form would occur which further causes the problem of loss of the functional components. In order to solve the above problems, it has been proposed that the strength of the capsule walls can be improved by increasing the thickness of the capsule walls, such as in a twice capsule wall building way. Obviously, this will inevitably prolong the process flow and further increase the production cost.

### SUMMARY

Taking into account the demands for a functional component in the coating industry, the inventor has designed a novel aqueous dispersion for sustained release of a functional component useful for a coating composition.

In one aspect, the present disclosure provides an aqueous dispersion for sustained release of a functional component useful for a coating composition, the aqueous dispersion comprising polymeric particles with a polymeric core-shell structure and the functional component contained in the polymeric core of the polymeric particles, wherein the polymeric shell has Tg of 20° C. or less, and wherein the functional component has a water solubility of 10 g/100 g water or less at room temperature. Preferably, the functional component has a water solubility of 7 g/100 g water or less at room temperature, more preferably, the functional component has a water solubility of 1 g/100 g water or less at room temperature, and still more preferably, the functional component has a water solubility of 0.5 g/100 g water or less at room temperature.

In an embodiment of the present disclosure, the concentration of the functional component in the polymeric particles is in the range of 1.5 to 50 mass %. In an embodiment of the present disclosure, the mass ratio of the polymeric core and the polymeric shell is in the range of 1:1 to 1:3.

In another aspect, the present disclosure provides a process for the preparation of an aqueous dispersion for sustained release of a functional component useful for a coating composition, and the process comprises the steps of:

a. in the presence of the functional component, carrying out an emulsion polymerization of a monomer mixture, thereby forming a polymeric core in which the functional component is included; and

b. in the presence of a seed emulsion containing the polymeric core, carrying out an emulsion polymerization of another monomer mixture, thereby forming polymeric particles having a core-shell structure, wherein the polymeric shell has Tg of 20° C. or less; and wherein the functional component has a water solubility of 10 g/100 g water or less at room temperature, preferably 7 g/100 g water or less.

In another aspect, the present disclosure provides a process for the preparation of an aqueous dispersion for sustained release of a functional component useful for a coating composition, and the process comprises the steps of:

a. carrying out an emulsion polymerization of a monomer mixture, thereby forming a polymeric shell; and

b. swelling the resulting emulsion with another monomer mixture and the functional component and carrying out in-situ emulsion polymerization of the another monomer mixture to form a polymeric core in which the functional component is included, thereby forming polymeric particles having a core-shell structure, wherein the polymeric shell has Tg of 20° C. or less; and wherein the functional component has a water solubility of 1 g/100 g water or less at room temperature, preferably 0.5 g/100 g water or less.

In another aspect, the present disclosure provides an aqueous coating composition, comprising water, a film-forming amount of a film-forming resin, and conventional additives, wherein the film-forming resin comprises the aqueous dispersion of the present disclosure.

The aqueous dispersion of the present disclosure comprises polymeric particles with a polymeric core-shell structure, wherein the polymeric shell is soft and has a relatively low glass transition temperature. On the one hand, the aqueous dispersion with the structure can be used as the film-forming resin capable of sustained release of functional components and is suitable for various coating compositions. On the other hand, as its polymeric shell is soft and has a strong flexibility, when the aqueous dispersion is used as the film-forming resin in the preparation process of the coating composition, the rupture of the shell caused by mechanical shearing can be avoided or greatly reduced, thereby avoiding or greatly reducing the loss of the functional component. In addition, the functional component is contained in the polymeric core of the polymeric particles with the polymeric core-shell structure, so that the present coating formed according to the present disclosure shows a longer period release effect as compared with the coating formed by a mixture of the functional component and a conventional aqueous dispersion.

In addition, the present aqueous dispersion of the present disclosure can be prepared in a simple, convenient and cheap way.

The details of one or more embodiments of the invention will be set forth in the description. According to the description and the claims, the other features, objectives, and advantages of the invention will become apparent.

### BRIEF DESCRIPTION OF DRAWING

FIG. 1 is a plot illustrating changes in the content of a functional component over time in each of samples: ▪ represents an aqueous dispersion of the present disclosure, which comprises a certain amount of the functional component; and ▴ represents the reference sample formed by a conventional aqueous dispersion and the same amount of the functional component.

### DETAILED DESCRIPTION

As used herein, “a”, “an”, “the”, “at least one”, and “one or more” are used interchangeably. Thus, for example, polymeric particles comprising “a” functional component can be interpreted to mean that the polymeric particles comprise “one or more” functional components.

Throughout the present disclosure, where a composition is described as having, including, or comprising specific components, it is contemplated that the composition as disclosed herein may further comprise other optional components, whether or not specifically mentioned in this disclosure, but it is also contemplated that the composition may consist essentially of, or consist of, the recited components. Also where a process is described as having, including, or comprising specific process steps, it is contemplated that the process as disclosed herein may further comprise other optional process steps, whether or not specifically mentioned in this disclosure, but it is also contemplated that the process may consist essentially of, or consist of, the recited steps.

For the sake of brevity, only certain ranges are explicitly disclosed herein. However, ranges from any lower limit may be combined with any upper limit to recite a range not explicitly recited, ranges from any lower limit may be combined with any other lower limit to recite a range not explicitly recited, and in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used with respect to a functional component, the phrase ‘being contained in the polymeric core of the polymeric particles’ means that the functional component may be aggregated at the center of the polymeric core or be distributed or even uniformly distributed throughout the polymeric core.

As used with respect to a functional component, the term ‘water solubility’ refers to the grams of the functional component dissolved in 100 g of water at a certain temperature when a saturated state is achieved. In the present disclosure, the water solubility of the functional component is determined according to GB/T21845-2008 at room temperature.

The terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

### Aqueous Dispersion

According to one aspect of the present disclosure, an aqueous dispersion for sustained release of a functional component useful for a coating composition is provided, the aqueous dispersion comprising polymeric particles with a polymeric core-shell structure and the functional component contained in the polymeric core of the polymeric particles, wherein the polymeric shell has Tg of 20° C. or less, and wherein the functional component has a water solubility of 10 g/100 g water or less at room temperature.

In the aqueous dispersion of the present disclosure, the polymeric particles have a polymeric core-shell structure in which the core is mainly formed by a polymer, constituting most of or all of the functional component; and the shell is also mainly formed by a polymer, substantially free of the functional component. When used with a polymeric core that may contain a functional component, the term “constituting most of or all of ” the functional component means that the polymeric core of the present disclosure contains at least 80% by weight, preferably at least 90% by weight, more preferably 95% by weight, still more preferably at least 98% by weight and most preferably 100% by weight, of the functional component. When used with a polymeric shell that may contain a functional component, the term “substantially free” of the functional component means that the polymeric shell of the present disclosure contains less than 20% by weight, preferably less than 10% by weight, more preferably less than 5% by weight, still more preferably less than 2% by weight and most preferably completely free of the functional component.

In the polymeric particles according to the present disclosure, the polymeric shell is soft and has Tg of 20° C. or less. As used herein, “Tg” denotes a glass transition temperature, at which temperature a polymer transitions from a glassy state to a rubbery state, or vice versa. Tg can be experimentally determined by using, for example, the differential scanning calorimetry (DSC), or calculated by using the Fox equation. Unless indicated otherwise, the values and ranges given for Tg in the present disclosure are those calculated by using the Fox equation.

According to the Fox equation, Tg (in K) of a copolymer having n copolymerized monomers can be given by the respective weight fractions W of the monomers and Tg (in K) of the respective homopolymers of each type of the monomers:

$$\frac{1}{Tg} = \frac{{W}_{1}}{{Tg}_{1}} + \frac{{W}_{2}}{{Tg}_{2}} + … + \frac{{W}_{n}}{{Tg}_{n}}$$

Tg thus given in K can easily be converted into Tg expressed in ° C.

Without wishing to be bound by theory, the inventors think that Tg of the polymeric shell greatly affects the capability of being coalesced into a film of the polymeric particles. The lower Tg of the polymeric shell, the better flexibility the shell has so that the polymeric particles can also be coalesced into the film at a relatively low temperature. Furthermore, during application procedure of the polymeric particles, the soft polymeric shell could tolerate the shearing force in the coating process avoiding or greatly reducing the occurrence of the rupture. According to the present disclosure, in order to render the polymeric particles to obtain the desired film-forming property and the desired processability such as the resistance to coating, the polymeric shell is designed to have a relatively low Tg. In embodiments of the present disclosure, the polymeric shell of the polymeric particles has Tg of at least 15° C. or less, preferably Tg of 10° C. or less, more preferably Tg of 0° C. or less and even more preferably Tg of −10° C. or less.

In a preferred embodiment of the present disclosure, the polymeric particles are designed to have a soft shell-hard core structure. Preferably, the glass transition temperature of the polymeric core is at least 10° C., preferably at least 15° C., more preferably at least 20° C. and even more preferably at least 25° C. or higher than that of the polymeric shell.

For the polymeric particles, “the mass ratio of the polymeric core and the polymeric shell” is calculated based on the ratio of the mass of a monomer or a monomer mixture forming the polymeric core (in which the functional component is not included) to the mass of a monomer or a monomer mixture forming the polymeric shell. In an embodiment of the present disclosure, the mass ratio of the polymeric core and the polymeric shell is in the range of 1:1 to 1:3. Generally, the smaller the mass ratio of the polymeric core and the polymeric shell of the polymeric particles, the lower the release rate of the functional component has; while the larger the mass ratio of the polymeric core and the polymeric shell, the higher the release speed of the functional component has. An appropriate polymeric core/shell mass ratio can be selected according to the desired release rate. In a preferred embodiment of the present disclosure, the mass ratio of the polymeric core and the polymeric shell of the polymeric particles is in the range of 1:1.8 to 1:2.2 and more preferably in the range of 1:1.98 to 1:2.02, so that the appropriate release rate of the functional component may be obtained.

In the polymeric particles according to the present disclosure, a functional component contained in the polymeric core is hydrophobic. In embodiments of the present disclosure, the functional component has a water solubility of 10 g/100 g water or less, preferably 7 g/100 g water or less, more preferably 1 g/100 g water or less and still more preferably 0.5 g/100 g water or less at room temperature. In the aqueous dispersion of the present disclosure, when the functional component has a relatively low water solubility (such as 1 g/100 g water or less), the functional component tends to be aggregated in the interior of the polymeric core to from a stable aqueous dispersion.

According to an embodiment of the present disclosure, in the aqueous dispersion of the present disclosure, the concentration of the functional component in the polymeric particles is in the range of 1.5 to 50 mass %. The concentration of the functional component in the polymeric particles can be calculated as follows: C functional component (% by weight)=RW functional component/S aqueous dispersion in which, C functional component represents the concentration of the functional component, calculated in % by weight, in the polymeric particles; RW functional component represents the weight percentage of the functional component used in preparation of the aqueous dispersion relative to the aqueous dispersion; and S aqueous dispersion represents the solid content of the prepared aqueous dispersion.

In the embodiment, the weight percentage of the functional component used in the preparation of the aqueous dispersion relative to the aqueous dispersion is in the range of 1-15% by weight, preferably in the range of 1-10% by weight, more preferably in the range of 1-8% by weight and still more preferably in the range of 2-6% by weight. Moreover, in the embodiment, the solid content of the prepared aqueous dispersion can vary in a wide range. Taking into account applicability in the coating industry, the solid content of the aqueous dispersion is in the range of 30-55% by weight, preferably in the range of 30-50% by weight, more preferably in the range of 35-48% by weight and still more preferably in the range of 35-45% by weight.

The concentration of the functional component falling within the above range can obtain the required effects associated with the functional component even under the situation of a relatively low loading amount of the aqueous dispersion.

Without wishing to be bound by the theory, the inventors think that after the aqueous dispersion of the present disclosure forms a film, the functional component contained in the polymeric core is released by being volatilized into gaseous molecules and passing through pores of the coating film or by being diffused to the outside of a coating due to the concentration difference between the polymeric core and the polymeric shell.

According to the present disclosure, the term “functional component” refers to the component capable of endowing the coating composition with the desired performance, such as the component capable of endowing the coating composition with energy storage, sterilization, fragrance, or other performance. According to the present disclosure, the functional component may be any functional component in the form of a liquid, a solid or a mixture of liquid and solid at room temperature (such as 20-30° C.) and a normal pressure (such as one atmospheric pressure).

In an embodiment of the present disclosure, the functional component comprises but without any limitation a phase transfer material, a repellent, an anti-bacterial agent, a fungicide, an essence oil, a perfume, a formaldehyde scavenging agent, an acid scavenging agent known as an acid corrosion inhibitor, a color-changing agent or the combination thereof.

As examples of the phase transfer material, an inorganic crystalline hydrate, a C15-C24 paraffin, a fatty acid, a fatty alcohol or the combination thereof may be given. As examples of the repellent, diethyltoluamide, lemon eucalyptus oil, dimethyl phthalate, pyrethroid, natural pyrethrin, or the like may be given. As examples of the anti-bacterial agent, alkyl quaternary ammonium salts (such as benzyl dimethyl dodecyl ammonium chloride), imidazoles (such as 2-(4-thiazolyl)-benzimidazole), pyridines (such as 2-pyridinol-1-sodium oxide), organic metals (such as zinc pyrithione and copper 8-quinolinolate), or the like may be given. As examples of the fungicide, a phenol type fungicide, a chlorophenol type fungicide, an ester type fungicide, a heterocyclic fungicide, an amide type fungicide, an organic metal salt fungicide, an inorganic salt fungicide or any combination thereof may be given. As examples of the essence oil, a lavender essential oil, a lemon grass essential oil, a peppermint essential oil, a tea tree essential oil, a tangerine essential oil, or the like may be given. As examples of the perfume, the perfumes derived from natural raw materials, such as pepper, clove, nutmeg, cinnamon, the like or from synthetic perfumes, such as coumarin, linalool, ionone, terpineol, geraniol, irone, turpentine oil, citronellal, or the like may be given. As examples of the formaldehyde scavenging agent, amines, phenols, esters, or the like may be given. As examples of the acid scavenging agent, triazoles, thiazoles, borate salts, silicate salts, phosphate salts, benzoate salts, nitrate salts, nitrite salts and molybdate salts may be given.

In a preferred embodiment of the present disclosure, the functional component comprises a combination of a phase transfer material having a phase-transfer temperature of 10 to 50° C. and an insect repellent, particularly preferably a combination of a solid-liquid phase transfer material having a phase-transfer temperature of 10 to 50° C. and an insect repellent such as a mosquito repellent, a cockroach repellent, an ant repellent or a lice repellent.

Preparation of Aqueous Dispersion

According to another aspect of the present disclosure, a process for the preparation of an aqueous dispersion for sustained release of a functional component useful for a coating composition is provided, and the process comprises the steps of: a. in the presence of the functional component, carrying out an emulsion polymerization of a monomer mixture, thereby forming a polymeric core in which the functional component is included; and b. in the presence of a seed emulsion containing the polymeric core, carrying out an emulsion polymerization of another monomer mixture, thereby forming polymeric particles having a core-shell structure, wherein the polymeric shell has Tg of 20° C. or less; and wherein the functional component has a water solubility of 10 g/100 g water or less at room temperature, preferably a water solubility of 7 g/100 g water or less at room temperature (hereinafter referred to as “a shell encapsulating core process”).

According to another aspect of the present disclosure, a process for the preparation of an aqueous dispersion for sustained release of a functional component useful for a coating composition is provided, and the process comprises the steps of: a.

carrying out an emulsion polymerization of a monomer mixture, thereby forming a polymeric shell; and b. swelling the resulting emulsion with another monomer mixture and the functional component and carrying out in-situ emulsion polymerization of the another monomer mixture to form a polymeric core in which the functional component is included, thereby forming polymeric particles having a core-shell structure, wherein the polymeric shell has Tg of 20° C. or less; and wherein the functional component has a water solubility of 1 g/100 g water or less at room temperature, preferably a water solubility of 0.5 g/100 g water or less at room temperature (hereinafter referred to as “a core swelling shell process”).

In the preparation of the disclosed aqueous dispersion, the “shell encapsulating core” process or the “core swelling shell” process can be used depending on water solubility of the functional component.

The emulsion polymerization technology for the preparation of an aqueous dispersion from ethylenically unsaturated monomers is well known in the art; here can be used any conventional emulsion polymerization process, such as a single-stage polymerization process, a multi-stage polymerization process, and a continuous process. It is well known that use of a seed polymerization process for the preparation of an aqueous dispersion may control the structure and composition of polymeric particles contained in the aqueous dispersion.

In an embodiment of the present disclosure, an aqueous dispersion is prepared by a) with the aid of an appropriate emulsifier, dispersing a functional component and a monomer mixture in which a hard monomer is dominant in water to form an emulsion and then adding dropwise the thus-formed emulsion into a polymerization reactor containing a polymerization initiator, thereby forming a seed emulsion as a polymeric core; and b) in the presence of the seed emulsion and optionally in the presence of an appropriate emulsifier, carrying out an emulsion polymerization of another monomer mixture in which a soft monomer is dominant, thereby forming polymeric particles having a core-shell structure. Preferably, the functional component is soluble in the monomer mixture from which the polymeric core is formed.

In another embodiment of the present disclosure, an aqueous dispersion is prepared by a) with an aid of an appropriate emulsifier and with stirring, dispersing a monomer mixture in which a soft monomer is dominant in water to form an emulsion, then adding dropwise the thus-formed emulsion into a polymerization reactor containing a polymerization initiator, thereby forming a seed emulsion as a polymeric shell; and b) swelling the formed seed emulsion with a functional component and another monomer mixture in which a hard monomer is dominant, carrying out an emulsion polymerization of the another monomer mixture, thereby forming polymeric particles having a core-shell structure. Preferably, the functional component is soluble in the monomer mixture from which the polymeric core is formed to form a mixture, by which mixture the formed polymeric shell will be swelled. According to the present disclosure, the polymeric core of the polymeric particles is formed by polymerizing a monomer mixture comprising, relative to the total weight of the monomer mixture, 60 to 90% by weight of a hard ethylenically unsaturated monomer of which homopolymer has Tg of greater than 25° C.; 4 to 30% by weight of a soft ethylenically unsaturated monomer of which homopolymer has Tg of less than 15° C.; 1 to 20% by weight of a multi-functional ethylenically unsaturated monomer; and 0 to 10% by weight of an ethylenically unsaturated monomer with an acid functionality.

According to the present disclosure, the polymeric core of the polymeric particles is formed by polymerizing another monomer mixture comprising, relative to the total weight of the another monomer mixture, 60 to 90% by weight of a soft ethylenically unsaturated monomer of which homopolymer has Tg of less than 15° C.; 4 to 30% by weight of a hard ethylenically unsaturated monomer of which homopolymer has Tg of greater than 25° C.; 1 to 20% by weight of a multi-functional ethylenically unsaturated monomer; and 0 to 10% by weight of an ethylenically unsaturated monomer with an acid functionality.

### i) Hard Ethylenically Unsaturated Monomer

In the preparation of the disclosed aqueous dispersion, any hard ethylenically unsaturated monomer may be used. In the present disclosure, a “hard ethylenically unsaturated monomer” refers to an ethylenically unsaturated monomer of which homopolymer has Tg of greater than 25° C. In an embodiment of the present disclosure, the hard ethylenically unsaturated monomer is selected from styrenics, (meth)acrylates, (meth)acrylonitriles and the combination thereof. In a preferred embodiment of the present disclosure, the hard ethylenically unsaturated monomer is selected from styrene, methyl methacrylate and the combination thereof.

In the aqueous dispersion of the present disclosure, the polymeric core comprises, relative to the total weight of the monomer mixture from which the polymeric core is formed, 60 to 90% by weight, preferably 65-90% by weight and more preferably 70-85% by weight of the hard ethylenically unsaturated monomer. In the aqueous dispersion of the present disclosure, the polymeric shell comprises, relative to the total weight of the monomer mixture from which the polymeric shell is formed, 4 to 30% by weight, preferably 5-25% by weight and more preferably 8-20% by weight of the hard ethylenically unsaturated monomer.

### i) Soft Ethylenically Unsaturated Monomer

In the preparation of the disclosed aqueous dispersion, any soft ethylenically unsaturated monomer may be used. In the present disclosure, a ‘soft ethylenically unsaturated monomer’ refers to an ethylenically unsaturated monomer of which homopolymer has Tg of less than 15° C. In an embodiment of the present disclosure, the soft ethylenically unsaturated monomer is selected from C3-C12 alkyl (meth) acrylates, vinyl acetate and the combination thereof. In a preferred embodiment of the present disclosure, the soft ethylenically unsaturated monomer is selected from butyl acrylate, 2-ethylhexyl acrylate, ethyl acrylate and the combination thereof.

In the aqueous dispersion of the present disclosure, the polymeric core comprises, relative to the total weight of the monomer mixture from which the polymeric core is formed, 4 to 30% by weight, preferably 5-25% by weight and more preferably 10-20% by weight of the soft ethylenically unsaturated monomer. In the aqueous dispersion of the present disclosure, the polymeric shell comprises, relative to the total weight of the monomer mixture from which the polymeric shell is formed, 60 to 90% by weight, preferably 70-90% by weight and more preferably 75-90% by weight of the soft ethylenically unsaturated monomer.

iii) Multi-functional Ethylenically Unsaturated Monomer

In the preparation of the disclosed aqueous dispersion, any multi-functional ethylenically unsaturated monomer may be used. In the present disclosure, a “multi-functional ethylenically unsaturated monomer” refers to a monomer with two or more, preferably three and even four ethylenically unsaturated functionalities playing a cross-linking role. In an embodiment of the present disclosure, the multi-functional ethylenically unsaturated monomer is selected from tripropylene glycol di(meth)acrylate, dipropylene glycol di(meth)acrylate; 1,6 hexanediol di(meth)acrylate, ethoxylated hexanediol di(meth)acrylate; 1,4-butanediol di(meth)acrylate; neopentyl glycol di(meth)acrylate; propoxylated neopentyl glycol di(meth)acrylate; 4-ethoxylated bisphenol A di(meth)acrylate; trimethylol propane tri(meth)acrylate; ethoxylated trimethylol propane tri(meth)acrylate; propoxylated glyceryl tri(meth)acrylate; pentaerythritol tri(meth)acrylate; di-trimethylol propane tetra(meth)acrylate and the combination thereof. In a preferred embodiment of the present disclosure, the multi-functional ethylenically unsaturated monomer is selected from pentaerythritol triacrylate, trimethylol propane triacrylate or the combination thereof.

In the preparation of the disclosed aqueous dispersion, the amount of the multi-functional ethylenically unsaturated monomer used has a significant effect on the release rate of the functional component from the formed film. Generally, the larger the amount of the multi-functional ethylenically unsaturated monomer, the higher the cross-linking density is, rendering the release rate of the functional component to be decreased. In contrast, the smaller the amount of the multi-functional ethylenically unsaturated monomer, the lower the cross-linking density is, thereby being unfavorable to obtain sustained release of the functional component. In the present disclosure, the amount of the multi-functional ethylenically unsaturated monomer is selected depending on the desired release rate. In an embodiment of the present disclosure, the polymeric core comprises, relative to the total weight of the monomer mixture from which the polymeric core is formed, 1 to 20% by weight, preferably 1-10% by weight and more preferably 2-8% by weight of the multi-functional ethylenically unsaturated monomer. In an embodiment of the present disclosure, the polymeric shell comprises, relative to the total weight of the monomer mixture from which the polymeric core is formed, 1 to 20% by weight, preferably 1-10% by weight and more preferably 1-5% by weight of the multi-functional ethylenically unsaturated monomer.

iv) Ethylenically Unsaturated Monomer with Acid Functionality

In the preparation of the disclosed aqueous dispersion, any ethylenically unsaturated monomers with an acid functionality may be used. The presence of the ethylenically unsaturated monomer with the acid functionality may additionally improve the stability for the dispersion.

In an embodiment of the present disclosure, the ethylenically unsaturated monomers with the acid functionalities comprise an ethylenically unsaturated monomer with a carboxylic acid functionality, an ethylenically unsaturated monomer with a phosphoric acid functionality or an ethylenically unsaturated monomer with a sulfonic acid functionality. In a preferred embodiment of the present disclosure, as an example of the ethylenically unsaturated monomer with the acid functionality, an ethylenically unsaturated monomer with a carboxylic acid functionality may be used. Examples of the ethylenically unsaturated monomer with the carboxylic acid functionality comprise acrylic acid, methacrylic acid, β-acryloxypropionic acid, ethylacrylic acid, α-chloroacrylic acid, crotonic acid, α-phenylacrylic acid, cinnamic acid, chlorocinnamic acid, itaconic acid, maleic acid or the combination thereof. Preferably, acrylic acid is used as an example.

In an embodiment of the present disclosure, the polymeric core comprises, relative to the total weight of the monomer mixture from which the polymeric core is formed, 0 to 10% by weight, preferably 0-5% by weight and more preferably 0-2% by weight of the ethylenically unsaturated monomer with the acid functionality. In an embodiment of the present disclosure, the polymeric shell comprises, relative to the total weight of the monomer mixture from which the polymeric shell is formed, 0 to 10% by weight, preferably 0-5% by weight and more preferably 0-2% by weight of the ethylenically unsaturated monomer with the acid functionality. Use of a relatively small amount of ethylenically unsaturated monomer with the acid functionality is favorable to obtain a stable aqueous dispersion. Thus, the amount of the ethylenically unsaturated monomer with the acid functionality, relative to the total weight of the various monomers used in the preparation of the aqueous dispersion, is in the range of 0-1% by weight preferably.

The polymerizable monomers' dispersing may be promoted by any suitable emulsifier. Suitable examples of the emulsifier include an anionic surfactant, a non-ionic surfactant, or a combination thereof. These surfactants are well known in the art. For example, some surfactants suitable for emulsion polymerization are disclosed in McCutcheon's Detergents and Emulsifiers, by Glen Rock, N.J., MC Publishing Co. Other types of stabilizer such as a protective colloid may also be used. Preferably, a combination of an anionic surfactant and a non-ionic surfactant is used. The anionic surfactant includes aliphatic carboxylate salts, aliphatic sulfonate salts, aliphatic sulfate salts, and aliphatic phosphate salts. Preferably, the salts of alkali metal such as Na, K, and Li, or alkali earth metal such as Ca and Ba may be used. In a specific example of the present disclosure, an aliphatic sulfonate salt, preferably alkali metal dodecyl sulfonate, in particular sodium dodecyl sulfonate (SDS) is used. The non-ionic surfactant includes alkyl phenol polyethylene oxide ether and aliphatic alcohol polyethylene oxide ether. Preferably, alkyl phenol polyethylene oxide ether is used. In a specific embodiment, octyl phenol polyethylene oxide ether (OP-10) is used.

Any suitable radical initiator may be used to initiate the polymerization reaction. Suitable examples of the initiator include those that generate free radical species by thermal decomposition at a temperature of polymerization. The initiators may include water soluble initiators and water insoluble initiators. The specific examples of the radical initiators include persulfates, such as ammonium persulfate or alkali metal (including potassium, sodium or lithium) persulfates; peroxides, such as cumene hydroperoxide, t-butyl hydroperoxide, di-t-butyl peroxide, dioctyl peroxide, tert-butyl peroxypivalate, t-butyl perisonoanoate, t-butyl peroctoate, tert-butyl peroxyneodecanoate, bis(2-ethylhexyl) peroxydicarbonate, di-isotrydecyl peroxydicarbonate; azo compounds, such as 2,2′-azo-bis(isobutyronitrile), 2,2′-azo-bis(valeronitrile); and the conventional redox systems. Preferably, a water soluble persulfate is used as the initiator. In particular, ammonium persulfate is used as the initiator.

For the preparation of an aqueous latex according to the present disclosure, the amounts of emulsifier and initiator and as well the reaction conditions such as the reaction temperature, the speed of stirring, and so on may be empirically determined by a person skilled in the art. Preferably, a pre-emulsification process of the monomer mixture is performed at the stirring speed of 2000rpm or higher, more preferably at the stirring speed of 4000rpm or higher.

### Aqueous Coating Composition

In yet still another aspect of the present disclosure, there is provided an aqueous coating composition, comprising water, a film-forming amount of a film-forming resin, and conventional additives, wherein the film-forming resin is the aqueous dispersion according to the present disclosure.

As used herein, the term “a film-forming resin” refers to any aqueous latex commonly used to carry out the film-formation in the field of coating. The film-forming resins commonly used include aqueous latexes of organic silicones, styrene-acrylates, acrylates, organic silicones modified acrylates, vinyl acetate, vinyl acetate-acrylates, vinyl acetate-ethylene, ethylene-vinyl acetate, vinyl acetate-acrylates-ester of versatic acid (e.g., vinyl ester of versatic acid, Veo Va 10), or fluorocarbon polymer, or any combination thereof.

An aqueous latex useful as the film-forming resin of the aqueous coating composition may be prepared by any suitable process for the preparation of an aqueous latex that is well-known to a person skilled in the art. Alternatively, as a specific example of the film-forming resin, any suitable product commercially available, such as the aqueous latex of styrene-acrylates available from BATF Industry Co., Ltd. under the trade name of RS 998A, RS 968 or RS 936W, may be used.

As can be readily appreciated by a person skilled in the art, the aqueous coating composition comprises the film-forming resin in a film-forming amount. Preferably, the amount of the film-forming resin comprised by the aqueous coating composition is in the range of from about 5 to 45% by weight relative to the total weight of the aqueous coating composition. Preferably, the amount of the film-forming resin comprised by the aqueous coating composition is at least about 10%, more preferably at least about 15%, and even more preferably about 20% by weight relative to the total weight of the aqueous coating composition. Preferably, the amount of the film-forming resin comprised by the aqueous coating composition is up to about 40%, more preferably up to about 35%, and even more preferably about 30% by weight relative to the total amount of the aqueous coating composition.

In the aqueous coating composition of the present disclosure, the aqueous dispersion of the present disclosure constitutes a portion of or all of the film-forming resin. In an embodiment of the present disclosure, the aqueous dispersion of the present disclosure accounts for 5-50% by weight of the film-forming resin.

Additional water may be added in formulating the aqueous coating composition to adjust the viscosity of the aqueous coating composition. The amount of water added may vary depending on the desirable viscosity and processability of the aqueous coating composition. Preferably, the amount of water added is, relative to the total weight of the aqueous coating composition, in the range of from about 15 to 40% by weight, preferably from 15 to 35% by weight.

The aqueous coating composition may further comprise one or more conventional additives that do not adversely affect the coating composition or coating obtained therefrom. Suitable additives include, for example, those that can be used to improve the processability or manufacturability of the composition, enhance composition aesthetics, improve a particular functional property or characteristic of the coating composition or the cured composition resulting therefrom, such as adhesion to a substrate, or reduce the cost of production. For example, suitable examples of the additive include a filler, a lubricating agent, a film-forming aid, a wetting agent, a plasticizer, a cross-linking agent, a defoamer, a coloring agent, a wax, an antioxidant, a flow control agent, a thixotropic agent, a dispersant, an adhesion promoter, a UV stabilizer, a thickener, a defoamer, a pH adjuster, a solvent or the combination thereof. Each optional ingredient can be included in a sufficient amount to serve its intended purpose, but preferably not in such an amount to adversely affect the coating composition or cured coating obtained therefrom. In a preferred embodiment, the aqueous coating composition according to the present disclosure may comprise a thickener, a dispersant, a defoamer, a wetting agent, a pH adjuster, filler, a coalescent agent, a bactericide, a fungicide, or any combination thereof. According to the present disclosure, the total amount of the conventional additives is in the range of from about 0.1 to 79% by weight relative to the total weight of the aqueous coating composition.

In an embodiment of the present disclosure, the aqueous coating composition comprises, based on the total weight of the aqueous coating composition,

15 to 40% by weight of water,

5 to 45% by weight of the film-forming resin; and

0.1 to 79% by weight of the conventional additives,

wherein the amount of the aqueous dispersion is in the range of 5 to 50% by weight relative to the film-forming resin.

### EXAMPLES

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples are commercially available, and used directly as they were originally received.

### Measurement Method

Release performance:

An aqueous dispersion to be measured was coated on a glass plate by a 100 μm applicator to form a film, dried at room temperature for 72 h, and then frozen and vacuum-dried for 4 h to obtain a sample.

The thus-formed sample was placed in a constant-temperature oven of 50° C. was taken as a zero point, sampling was performed at different time periods (such as 1 h, 2 h, 3 h, . . . ), then the weight loss rate between 50° C. and 270° C. in the coated film was measured by a thermogravimetric analysis method (TGA) and results were recorded.

### Example 1

### Synthesis of Aqueous Dispersion

In a four-necked flask, a uniform mixture of 125 g of styrene, 25 g of butyl acrylate, 10 g of pentaerythritol triacrylate and 60 g of lavender essential oil was charged as a monomer mixture. Then, the monomer mixture was mixed with a solution of 5 g of sodium dodecyl sulfonate (SDS) and 2.5 g of octylphenol polyoxyethylene ether (OP-10) in 150 g of water and stirred at the speed of 5000 rpm/min for 1 h to form a pre-emulsion. In another four-necked flask equipped with a stirrer, a thermocouple and a condenser, 300 g of deionized water, 1 g of SDS, 0.5 g of OP-10 and 0.2 g of ammonium persulfate were charged and heated with stirring, and adding dropwise to the mixture thus-formed pre-emulsion after the mixture was heated to 80° C. over 2 h. When the addition was complete, the temperature was maintained at 80° C. for 0.5 h to form a seed emulsion.

In a four-necked flask, a uniform mixture of 40 g of methyl methacrylate, 260 g of butyl acrylate and 10 g of pentaerythritol triacrylate was added as a monomer mixture. Then, the mixture was mixed with a solution of 1 g of sodium dodecyl sulfonate (SDS) and 0.5 g of octylphenol polyoxyethylene ether (OP-10) in 150 g of water and stirred to form a pre-emulsion. To the seed emulsion, the thus-formed pre-emulsion and an initiator solution of 0.4 g of ammonium persulfate in 50 g of water were simultaneously added dropwise over 2 hours and at the same time, the temperature was kept at 80° C. When the addition was complete, the temperature was maintained at 80° C. for 1 h. The resulting mixture was cooled down and then adjusted by ammonia water to pH of 7.5-8.5. By calculation, the shell of thus-formed polymeric particles has Tg of −38° C. The synthesized aqueous dispersion could form a film at the temperature of 25° C.

### Example 2

### Synthesis of Aqueous Dispersion

In a four-necked flask, a uniform mixture of 40 g of methyl methacrylate, 260 g of butyl acrylate, and 10 g of pentaerythritol triacrylate was charged as a monomer mixture. Then, the monomer mixture was mixed with a solution of 5 g of sodium dodecyl sulfonate (SDS) and 2.5 g of octylphenol polyoxyethylene ether (OP-10) in 150 g of water and stirred at the speed of 5000 rpm/min for 1 h to form a pre-emulsion. In another four-necked flask equipped with a stirrer, a thermocouple and a condenser, 300 g of deionized water, 1 g of SDS, 0.5 g of OP-10 and 0.2 g of ammonium persulfate were charged and heated with stirring, and adding dropwise to the mixture thus-formed pre-emulsion after the mixture was heated to 80° C. over 2 h. When the addition was complete, the temperature was maintained at 80° C. for 0.5 h to form a seed emulsion.

To thus-formed seed emulsion, a mixture of 125 g of styrene, 25 g of butyl acrylate, 10 g of pentaerythritol triacrylate and 60 g of lavender essential oil was added with a solution of 1 g of sodium dodecyl sulfonate (SDS) and 0.5 g of octylphenol polyoxyethylene ether (OP-10) in 150 g of water and an initiator solution of 0.4 g of ammonium persulfate in 50 g of water over 3 hours and at the same time, the temperature was kept at 80° C. When the addition was complete, the temperature was maintained at 80° C. for 1 h. The resulting mixture was cooled down and then adjusted by ammonia water to pH of 7.5-8.5. By calculation, the shell of thus-formed polymeric particles has Tg of −38° C. The synthesized aqueous dispersion could form a film at the temperature of 25° C.

### Example 3

### Synthesis of Aqueous Dispersion

In a four-necked flask, a uniform mixture of 90 g of styrene, 10 g of butyl acrylate, 7.5 g of pentaerythritol triacrylate and 60 g of lavender essential oil was charged as a monomer mixture. Then, the monomer mixture was mixed with a solution of 5 g of sodium dodecyl sulfonate (SDS) and 2.5 g of octylphenol polyoxyethylene ether (OP-10) in 100 g of water and stirred at the speed of 5000 rpm/min for 1 h to form a pre-emulsion. In another four-necked flask equipped with a stirrer, a thermocouple and a condenser, 200 g of deionized water, 0.8 g of SDS, 0.4 g of OP-10 and 0.15 g of ammonium persulfate were charged and heated with stirring, and adding dropwise to the mixture thus-formed pre-emulsion after the mixture was heated to 80° C. over 2 h. When the addition was complete, the temperature was maintained at 80° C. for 0.5 h to form a seed emulsion.

In a four-necked flask, a uniform mixture of 15 g of methyl methacrylate, 110 g of butyl acrylate and 5 g of pentaerythritol triacrylate was added as a monomer mixture. Then, the mixture was mixed with a solution of 0.4 g of sodium dodecyl sulfonate (SDS) and 0.2 g of octylphenol polyoxyethylene ether (OP-10) in 90 g of water and stirred to form a pre-emulsion. To the seed emulsion, the thus-formed pre-emulsion and an initiator solution of 0.3 g of ammonium persulfate in 50 g of water were simultaneously added dropwise over 2 hours and at the same time, the temperature was kept at 80° C. When the addition was complete, the temperature was maintained at 80° C. for 1 h. The resulting mixture was cooled down and then adjusted by ammonia water to pH of 7.5-8.5. By calculation, the shell of thus-formed polymeric particles has Tg of −42° C. The synthesized aqueous dispersion could form a film at the temperature of 25° C.

### Example 4

### Release of Functional Component

A sustained release measurement was performed to the aqueous dispersion in which 100 g of aqueous dispersion in Example 3 containing about 8 g of lavender essential oil was used as the aqueous dispersion of the present disclosure; and a mixture of 92 g of commercially available aqueous styrene-acrylate dispersion RS 998A with about 8.0 g of lavender essential oil as a reference sample. Each of the two samples was measured according to the release performance test of the Measurement

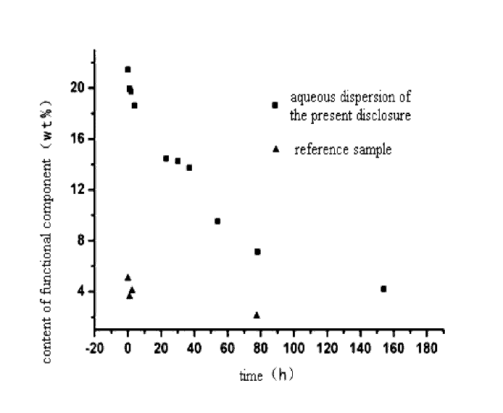

Method to obtain the release result of the lavender essential oil as a functional component in each of the two samples. The results were shown in FIG. 1.

From the results in FIG. 1, it was shown that the sample in which the functional component was included in the aqueous dispersion had a significant sustained release feature. With the reference sample in which the functional component was directly mixed with the aqueous dispersion, the content of the functional component in a formed film (namely the coating formed by drying the reference sample at room temperature for 72 h and then freezing and vacuum drying for 4 h) at the time of a zero point was only 5% by weight, indicating that the reference sample does not show the desired sustained release characteristic. In addition, the content of the functional component in the coating formed by an applicator at zero point was very close to the theoretical content of the functional component contained in the coating composition. This demonstrated that the application procedure does not cause the loss of the functional component.

### Example 5

### Aqueous Coating Composition

The aqueous dispersion of the present disclosure was mixed with water, a conventional film-forming resin and conventional additives (including a cellulose, a defoamer, a dispersant, a wetting agent, a pH adjuster, TiO₂, a filler, a film-forming aid, a fungicide and a preservative) to form the coating composition of the present disclosure. The composition of the coating composition was shown in the following Table 1.

TABLE 1
Formulation of Coating composition

| Ingredient | Amount | Source |
|---|---|---|
| Water | 15-40% | |
| Cellulose | 0.03-0.5% | Commercially available |
| Defoamer | 0.05-0.5% | Commercially available |
| Dispersant | 0.05-0.5% | Commercially available |
| wetting agent | 0.05-0.5% | Commercially available |
| pH adjuster | 0.05-0.5% | Commercially available |
| TiO₂ | 5-30% | Commercially available |
| filler | 10-60% | Commercially available |
| Conventional film-forming resin | 5-30% | Commercially available |
| Aqueous dispersion of the present | 5-15% | Self-made |
| disclosure | | |
| Film-forming aid | 1-10% | Commercially available |
| Fungicide | 0.05-0.2% | Commercially available |
| Preservative | 0.05-0.2% | Commercially available |

Above coating composition showed a significant sustained release feature when used as a coating for a wall.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed:

1. An aqueous dispersion for sustained release of a functional component in a coating composition, the aqueous dispersion comprising polymeric particles having a polymeric core-shell structure with the functional component contained in the polymeric core of the polymeric particles,
wherein the polymeric shell has Tg no more than of 20° C.; and
wherein the functional component has a water solubility of no more than 10 g/100 g water at room temperature.

2. The aqueous dispersion according to claim 1, wherein the functional component has a water solubility of no more than 7 g/100 g water at room temperature.

3. The aqueous dispersion according to claim 1, wherein the functional component has a water solubility of no more than 1 g/100 g water at room temperature.

4. The aqueous dispersion according to claim 3, wherein the functional component has a water solubility of no more than 0.5 g/100 g water at room temperature.

5. The aqueous dispersion according to claim 1, wherein the concentration of the functional component in the polymeric particles is in the range of about 1.5 to 50 mass %.

6. The aqueous dispersion according to claim 1, wherein the mass ratio of the polymeric core and the polymeric shell is in the range of about 1:1 to 1:3.

7. The aqueous dispersion according to claim 1, wherein the functional component is in the form of a liquid, or solid or a mixture of a liquid and a solid at room temperature and atmospheric pressure.

8. The aqueous dispersion according to claim 7, wherein the functional component is selected from a phase transfer material, a repellent, a fungicide, an anti-bacterial agent, an essence oil, a perfume, a formaldehyde scavenging agent, an acid scavenging agent, a color-changing agent, or combinations thereof.

9. The aqueous dispersion according to claim 6, wherein the functional component comprises a combination of a phase transfer material having a phase-transfer temperature of 10 to 50° C., and an insect repellent.

10. The aqueous dispersion according to claim 1, wherein the polymeric core is formed by polymerizing a monomer mixture comprising, relative to the total weight of the monomer mixture,
i) 60 to 90% by weight of a hard ethylenically unsaturated monomer of which homopolymer has Tg of greater than 25° C.;
ii) 4 to 30% by weight of a soft ethylenically unsaturated monomer of which homopolymer has Tg of less than 15° C.;
iii) 1 to 20% by weight of a multi-functional ethylenically unsaturated monomer; and
iv) 0 to 10% by weight of an ethylenically unsaturated monomer with an acid functionality.

11. The aqueous dispersion as claimed in claim 1, wherein the polymeric shell is formed by polymerizing, a monomer mixture comprising, relative to the total weight of the another monomer mixture,
i) 60 to 90% by weight of a soft ethylenically unsaturated monomer of which homopolymer has Tg of less than 15° C.;
ii) 4 to 30% by weight of a hard ethylenically unsaturated monomer of which homopolymer has Tg of greater than 25° C.;
iii) 1 to 20% by weight of a multi-functional ethylenically unsaturated monomer; and
iv) 0 to 10% by weight of an ethylenically unsaturated monomer with an acid functionality.

12. The aqueous dispersion according to claim 10, wherein the hard ethylenically unsaturated monomer is selected from styrenes, (meth)acrylates, (meth)acrylonitriles or the combination thereof.

13. The aqueous dispersion according to claim 11, wherein the hard ethylenically unsaturated monomer is selected from styrenes, (meth)acrylates, (meth)acrylonitriles or the combination thereof.

14. The aqueous dispersion according to claim 12, wherein the hard ethylenically unsaturated monomer is selected from styrene, methyl methacrylate or the combination thereof.

15. The aqueous dispersion according to claim 13, wherein the hard ethylenically unsaturated monomer is selected from styrene, methyl methacrylate or the combination thereof.

16. The aqueous dispersion according to claim 10, wherein the soft ethylenically unsaturated monomer is selected from C3-C12 alkyl (meth)acrylates, vinyl acetate or the combination thereof.

17. The aqueous dispersion according to claim 11, wherein the soft ethylenically unsaturated monomer is selected from C3-C12 alkyl (meth)acrylates, vinyl acetate or the combination thereof.

18. The aqueous dispersion according to claim 17, wherein the soft ethylenically unsaturated monomer is selected from butyl acrylate, 2-ethylhexyl acrylate, ethyl acrylate or the combination thereof.

19. The aqueous dispersion according to claim 18, wherein the soft ethylenically unsaturated monomer is selected from butyl acrylate, 2-ethylhexyl acrylate, ethyl acrylate or the combination thereof.

20. The aqueous dispersion according to claim 1, wherein the glass transition temperature of the polymeric core is at least 10° C. higher than that of the polymeric shell.
